(19) United States
(12) Patent Application Publication
(10) Pub. No.: US 2002/0024452 A1
(43) Pub. Date: Feb. 28, 2002

(54) Integral building control system

(76) Inventor: Gary Hager, New Vienna, IA (US)

Correspondence Address: Angenehm Law Firm Ltd., 15612 Highway 7 #320, Minnetonka, MN, 55345, US

(21) Appl. No.: 09/860,792

(22) Filed: May 18, 2001

Related U.S. Application Data
(60) Provisional application No. 60/183,878, filed on Feb. 22, 2000.

(51) Int. Cl. G08B 21/00

(52) U.S. Cl. 340/999; 340/540

(57) ABSTRACT

A control system for a building, the building having walls and each of the walls containing a plurality of support studs, the control system having at least one control and communications module attached to and affixed in a wall of the building, the control module having a chassis sized to fit between and attach to a pair of adjacent studs, the chassis further being adapted to accept at least one function module, at least one mechanism for providing input to the at least one function module, at least one port or device to providing human sensible output from the at least one function module, and means for providing communications among the control and communications modules.

### FIELD OF THE INVENTION

The invention relates to a modular building control system, and more particularly an integral building control system adapted to manage communications and environment within and without the building, especially a house.

### BACKGROUND

In the current times, the complexity of managing a building, or even a home is ever increasing. The quantity of information that is processed in the day-to-day management of the building is increasing to the point that the average homeowner can be overwhelmed by the sheer volume of data. For example, in a modern home the home owner often has a security system, phone system, an entertainment system, and a communications system. Historically, these systems were first installed as discrete and separate systems. The systems have remained separate and discrete systems with no interoperability.

With the increasing amounts of technology that is being put into buildings today the discrete technological systems have reached the point that technology is occupying an increasing amount of space within the typical building, using an increasing amount of energy, and an increasing amount of the occupant's time. Additionally, the modern people's schedules have become fuller and fuller as evidenced by the increased use scheduling devices, calendars, communications, and other electronic assistants.

For example, the home of a busy person in the current times will have an internet connection with e-mail, a security system to protect the home and its contents from burglary, in many climates, a lawn sprinkler system, a home entertainment system, and various “smart” and “dumb” appliances. None of these systems is aware of any of the other systems and each system works independently without recognition of any of the other systems. This independence creates unnecessary redundancies and conflict in the home that are neither efficient nor cost effective.

Another discrete home technology device that has become very common is the home computer. In some homes, it has become common to have multiple home computers and to even network the home computers together. While home computers are very useful, and often seemingly necessary, they have inherent shortcomings, for example, often a computer is not in the location where it is needed and the information must be printed on paper and taken to another location for use or alternately, the information is on another computer, or is not current on the computer that is being used. Another problem is that computer and their associated accessories occupy space on desks or counters and tend to spread to cover all of the available space and the cords connecting the computer to the accessories create a tangled mess.

### SUMMARY OF THE INVENTION

The wall mount computer as disclosed is a modular computer system having a chassis permanently mounted within the wall of a structure. The chassis is designed to accept modular function modules that can be easily installed in the chassis after the structure is completed. Wiring to provide power and interconnectivity where multiple chassis are installed is placed permanently within the walls of the structure. The wiring or cabling can be installed during construction to provide the interconnection among the wall mount computers.

Conventional construction in the United States involves the use of stud walls, that is, walls formed having structural studs of “two by” dimensional lumber, most commonly two by four or two by six lumber spaced so that the centers of the pieces of lumber are spaced apart either sixteen or twenty-four inches. This spacing is commonly referred to as on center (OC), that is 16″ OC. or 24″ OC. This construction practice leaves a space of 14.5 inches or 22.5 inches between each pair of studs. When exterior walls are thus constructed, it is common practice, and often required by building code to fill the spaces between the studs for energy efficiency. However, the interior walls usually contain empty stud spaces where a wall mount computer may be installed.

The wall mount computer being fitted into the otherwise empty space of a wall solves the problem of placing a computer and limits the mess of the tangle of cords often attendant to the conventional installation of a computer. The provision of permanent power wiring allows cleaner power to be provided to the computer and prevents the addition of accessories to the point of overloading an electrical circuit. The additional provision of permanent communication wiring allows multiple computers within the structure to be connected and communicate among the computers or their users.

All of the wall mount computers are designed so that installation can proceed with the conventional construction schedule of a new structure. After the walls of the building have been framed, the chassis of the wall mount computers and their associated wiring can be installed. After installation of the chassis, the other building trades, sheet rock, painting, trim carpenters can come in and do their work without the worry of having computers present. After the structure is completed, the functional modules are installed in the wall mount computer chassis and connected and tested. The installation of the functional modules is expected to be a simple plug in installation.

While the previous discussion has been directed toward new construction, the wall mount computer can also be installed in an existing structure. When a wall mount computer is to be installed in an existing structure, there are the added difficulties of snaking wiring through existing finished walls, it is no more difficult than any other remodeling that would require running wiring through a wall. Additionally, in a remodeling context, the entire wall mount computer can be installed at one time there being no need to wait for other tradesmen to finish the walls.

The quantity of function contained on each plug in module can be varied depending on the particular application. In some instances, it may be desired that a single module contained all of the computer and communications functions necessary for the operation of a particular chassis. In other instances, less functionality will be included on a module, for example, a single module may contain only the central processing unit (CPU) and other modules will contain mass storage and communications hardware. Should the future needs arise for additional functional modules to be placed in a chassis, they may be simply plugged-in for installation, thus enhancing the functionality of an existing chassis After the appropriate functional modules have been added to a chassis, the input and output hardware may be installed. A display is placed over the chassis and a keyboard may be also attached. Any other peripherals, such as, printers are also attached at this time. Thus, the installation of this wall mount computer is complete and the remaining wall mount computers may be installed. After all the wall mount computers are installed, the networking is installed and tested, the installation is complete.

Another specialized use for the wall mount computers is in the control of the environment within the building. While some structures have a dedicated discrete building control system for controlling the heating and cooling, this function has not converged with other systems into a unitary control system. Environmental control systems are being used in larger and commercial buildings but have not been migrated for use in a home, usually due to cost considerations. The wall mount computer system is able to provide the computing power necessary for this function and is able to accept input from standard sensors.

When multiple computers are networked within a structure, one or more of the computers may assume specialized tasks, such as serving as a file server, a gateway, a designated storage computer, or a specialized controller. An example of a specialized computer would be having a wall mount computer located in the entry way of a home designated to function as a communications center. Thus, this computer would be used to arm and disarm the burglar alarm, and when prompted could provide the user with his or her messages. The entry way computer would be designed to accept limited user input and provide limited output. This could be conveniently accomplished by fitting the computer with a touch screen to accept the user input, and the screen for the user to read the output. Neither printers nor keyboards would be necessary. Should the user desire to have a printed output, that output could be queued to a selected remote printer. Alternately, should an event require the use of a keyboard, the user can send the event to another of the wall mount computers having an attached keyboard.

Another example of a specialized use of a wall mount computer would be use in a kitchen where the wall mount computer would store recipes, shopping lists, and the like for easy access at the point of use. Again a touch screen can be used for input, allowing the user to select a recipe from the previously stored recipes, or select items to be placed on a shopping list from a previously stored list of items that are commonly used in the user's kitchen.

While the specialized wall mount computers use a touch screen for primary input, they will also have universal serial bus (USB) jacks for connection of standard peripherals such as keyboards, printers, microphones, or even mass storage devices.

In a typical installation of the wall mount computers, wall mount computers will be installed in the main entry way, the kitchen, the bedrooms, and the office. The entryway wall mount computer and the kitchen wall mount computer will be specialized models having the primary input by touch screen. The bedroom and office computers will be general purpose computers and will be adapted to have primary input by keyboard. One of the general purpose computers will, typically, be designated a gateway, that is, the gateway computer will be assigned the duty of controlling communications with the world outside of the structure, more specifically, the gateway wall mounted computer would be a gateway to the internet. One of the general purpose computers may also be designated as a file server or have other specific tasks.

Thus, the collection of wall mount computers in a structure can be networked together to cooperate in providing the functions needed in the modern home. The variety of data stored in the home would be accessible from any on the several wall mounted computers so that, for example, data stored on an office computer would be available at the entry way wall mount computer. With the use of a gateway, one of the wall mount computers would control internet access while all of the wall mount computers could access the internet through the gateway. A user could enter recipes into the system of wall mount computers from the most convenient location and have the recipes stored on the kitchen wall mount computer readily available for use in the kitchen.

The wall mount computer will provide for the convergence of digital data in many forms into one interconnected intercommunicating system. With the convergence of the digital data from many sources into one unified system, the use and management of all of the systems will become more convenient and simpler. It is hoped that in the future, other applications and hardware will be added to and connected with the system of wall mount computers. A simple example of an added appliance would be a coffee pot can be set so that the coffee pot begins to perk the morning coffee before the first alarm clock awakens the users thereby greeting arising users with fresh coffee.

The addition of a system of modular wall mounted computers to a home will organize and consolidate the digital processing power without using additional floor space and integrating the various uses into a single system. Every component of the wall mount computer system will be located in the walls or in a closet preserving the valuable floor space of the house for use by the users.

### BRIEF DESCRIPTION OF THE DRAWINGS

FIG. 1 is a front elevation view of the first embodiment of the wall mount computer as mounted in a wall of a structure.

FIG. 2 is a partial exploded view of the wall mount computer showing the chassis exploded from a mounting position within a wall of a structure.

FIG. 3 is a partial cut-away view of a wall of a structure prepared to receive a wall mounted computer.

FIG. 4 is front elevation view of a second embodiment of the wall mount computer as mounted in a wall of a structure.

FIG. 5 is a plan view of a second embodiment of the wall mount computer showing the movable articulated arm.

### DETAILED DESCRIPTION

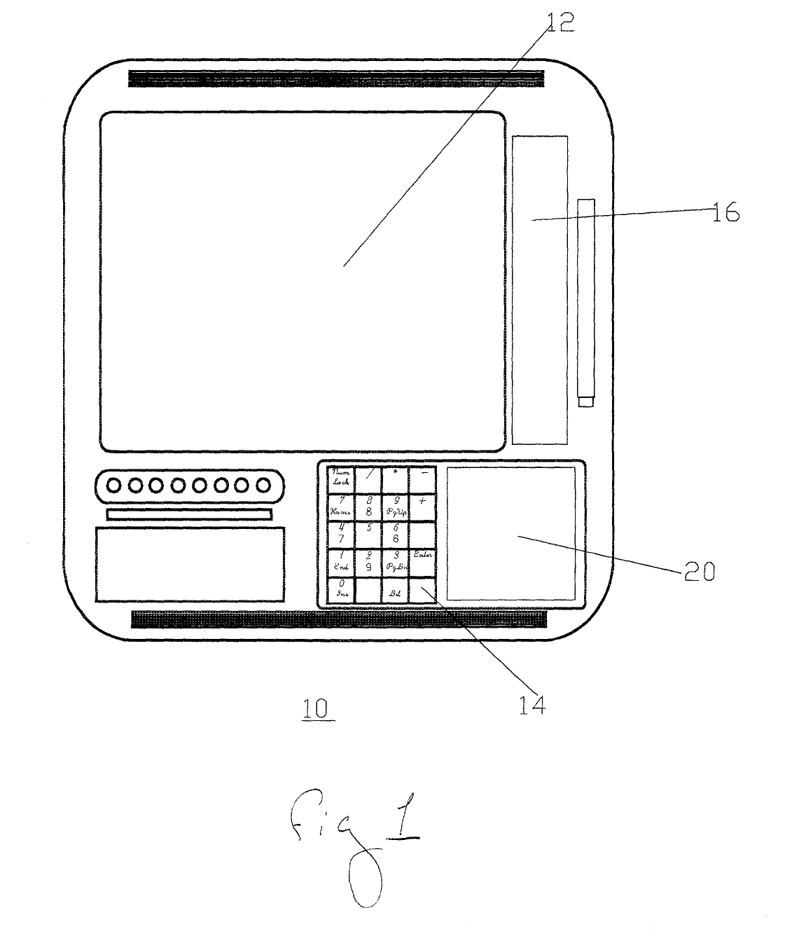

Looking first to FIG. 1 which shows the front elevation view of a wall mount computer 10 as the wall mount computer 10 would appear to a user. In this first embodiment of the wall mount computer 10, shows one of the specialized computers that is adapted to accept limited input and can function without a keyboard. The wall mount computer has a touch screen 12, a mini keyboard 14, a space for specialized input function keys 16, a button keyboard 18, and a peripheral connection area 20.

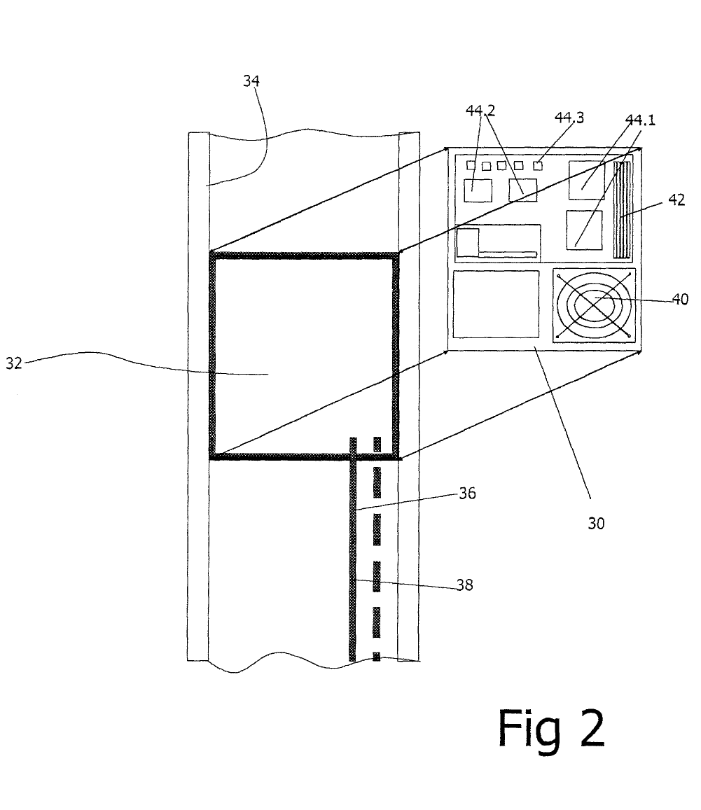

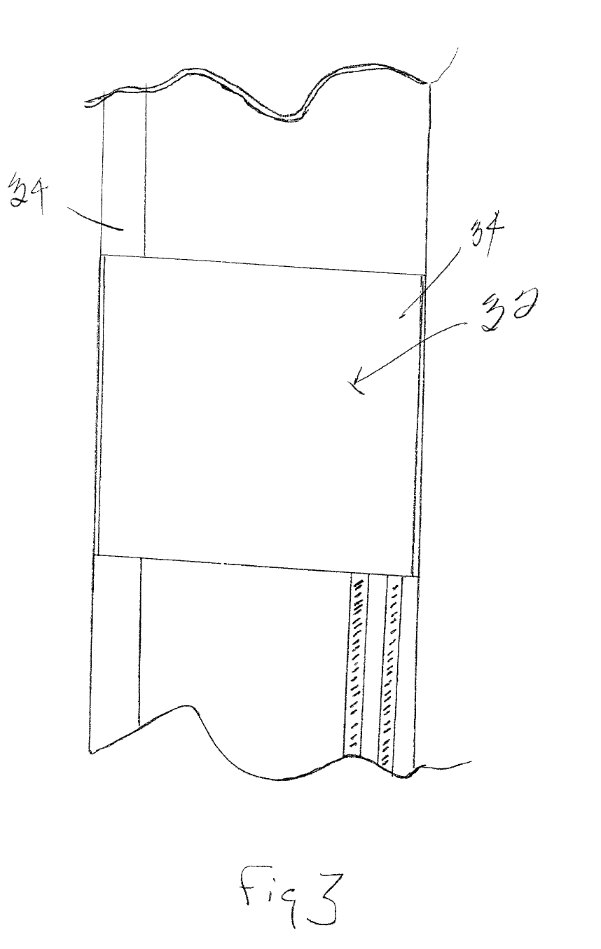

The installation of a wall mount computer 10 is shown more clearly in FIG. 2, which is a view showing the chassis 30 of a wall mount computer 10 exploded from a stud space 32. The stud space 32 has a pair of adjacent studs 34 spaced apart a conventional distance, typically 16′ OC or 24″ OC which will result in a nominal spacing between the adjacent edges of the studs 34 of either 14.5″ or 23.5.″ The actual spacing between the studs will vary slightly from the nominal spacing owing to the inconsistencies inherent in lumber and minor variation from the skill of the carpenter.

It is understood that the width of the chassis depends from available space within a wall and may be increased or decreased to suit the structure in which the wall mount computer 10 is installed.

An electric supply cable 36 is let into the stud space 32 for attachment to the chassis 30. The electric supply cable 36 has been previously connected to a suitable supply of electricity in compliance with the applicable electrical code requirements. The chassis 30 has suitable connection lugs (not shown) for attachment of the power supply cable. Connection lugs and the art of attachment of power cables is well known in the art and regulated by both national and local electrical codes and are readily available to those suitably skilled in the art.

A communications cable 38 is also let into the stud space 32 for attachment to the chassis 30. The communications cable 38 will be connected among the multiple wall mount computers 32. The communications cable 38 will carry communications among the wall mount computers and carry communications in from outside of the structure and from the structure to the outside. Communications cables 38 of the type used are varied and well known in the art and readily available from numerous vendors.

The chassis in FIG. 2 has a power supply 40 shown as integrated within the chassis. The inclusion of a power supply is an assembly choice and while it is frequently preferred to include the power supply 40, it is not necessary.

Expansion slots 42 are shown in the chassis 30. Function cards (not shown) are well standardized in the computer industry and often provide the most efficient way to add a function to a computer. The expansion slots 42 are conventionally included on a computer and it is advantageous to provide for the utilization of industry standard parts when possible for both efficiency and economy.

Additionally shown in chassis 30 of FIG. 2 are expansion slots 42 and function modules 44. The function modules 44 may be of a standard size, or may be of varying sizes as indicated by the small function modules 44.3, the medium function modules 44.2 and the large function modules 44.1. The selection of function modules 44 for inclusion in a wall mount computer 10 is based on the functionality desired from the function module 44 and showing the function modules 44 in varying sizes is merely for convenience. While present technology provides function modules of the size shown in FIG. 2, it is anticipated that future technology will provide further miniaturization of the function modules 44 and the reduced size of the function modules 44 does not detract from the wall mount computer 10.

The touch screen 12 is a typical screen adapted to accept tactile input from a user. Touch screens 12 of this type are well known in the art and readily available from standard supply channels. It is preferred that the touch screen 12 be thin in depth so that is does not encroach appreciably into the chassis 30. One type of suitable is display for a touch screen 12 is a liquid crystal display (LCD). A LCD screen 12 has the further advantage of having low power consumption.

Typically, the touch screen 12 would be programmed to the specialization of the particular wall mount computer 10 so that a user would have frequently used commands readily available on the touch screen 12. For example, when the wall mount computer 10 is functioning as a security system controller, commands available would include arming and disarming the security system. The security system codes that a user must enter, could be entered on the touch screen 12 or the mini keyboard 14. One of the advantages of the touch screen 12 is that the wall mount computer 10 can be programmed to provide the user with a hierarchical menu system that becomes more specific in response to user input while providing the user with a group of defined and labeled responses that changes in response to user input. For example, a main menu on the touch screen 12 can provide the user with access to the general functions allowed from that particular wall mount computer 10 allowing the user to select a specific area, such as security system or e-mail. Once the user selected an option, the menus would change with the context to reflect the user input.

An alternate method of input would be to provide a microphone (not shown) for use with a voice actuated system. The voice actuation would require the addition of a microphone and the associated hardware necessary to digitize the analog signal of the microphone. Additionally, software would also be required to recognize and execute the commands.

An alternate method of output method of output would be to have the wall mount computer 10 synthesize or otherwise produce sound responsive to user input. The benefit of voice control and aural output to the ordinary user would be that the voice actuation would also function as a “password” or identifier of the user, that is, the voice of the user would be required to match a voice of an authorized user. The “voice” out put would be utilized for a multitude of uses, including simply recognizing the user, acknowledging the input, or providing instructions to the user. An example of providing instructions to the user would be when a user is following a recipe to cook a something, the user could ask the wall mount computer 10 for the next step, and the wall mount computer would respond with the next step of the recipe. Thus, the user would have both hands free to cook, and would not be required to return to the cook book, find the next step, read the next step, and return to the cooking.

A second use of voice input and output would be for use by users who have physical limitations that preclude the use of traditional computer input and output. Fro example, a sightless person would be unable to see the monitor of a computer and could not read the output, even it the sightless person were able to type on the keyboard. A user with limited use of their hands would find it difficult or impossible to use a conventional keyboard, but, could use voice input.

The mini keyboard 14 is shown as a standard twenty key keypad, as is used in the numeric keypad in a standard computer keyboard. It is understood that the mini keyboard does not need to have any particular number of keys. The mini keyboard 14 is used to allow a user to provide limited input to the wall mount computer 10 and the keys of the mini keyboard 14 may be programmed for specific functions that enhance the usability of the particular application of the specialized wall mount computer 10.

One example of the use of the mini keyboard 14 would be when the wall mount computer 10 is located in the entry way of a building, and controls building security. In this use, the user would be required to input a code to arm the alarm system and code would be entered through the mini keyboard numerically. Another example, would when the wall mount computer 10 is specialized for kitchen use and the user would be using the keys of the mini keyboard 14 to search through recipes or select the number of portions needed for cooking.

When the wall mount computer 10 is used for general use, the touch screen 12 is no longer necessary and an ordinary screen 13 without the touch functions can be used for economic reasons. Alternately, a conventional monitor 13 may be connected through the appropriate connection in the peripheral connection area 20. With the use of a conventional monitor, it is anticipated that the monitor 13 would be placed on a conventional support device such as a desk or the like.

The specialized function keys 16 are preprogrammed keys that are provided for user input and may be left as programmed as on a standard computer keyboard, or may be reprogrammed by the vendor or by a skilled user for a specific use of that user. The programming of the specialized function 16 may be varied as particular applications are running.

The button keyboard 18 is used to provide system commands and would include such controls as a power switch and display controls. The display controls on the button keyboard would control such things as the contrast, brightness, and color of the touch screen 12 display and may also control the volume of the sound.

The peripheral connection area 20 is a location where connections can be made to various peripherals. In the peripheral connection area 20 there would be, at least, one and preferably two USB connections to provide for the connection of a mouse (not shown) or other pointing device or a keyboard (not shown). Additionally, other devices, such as printers or removable media drives can be attached through USB connectors. The removable media drives can include conventional drives for floppy disks, Bernoulli principle drives such as those sold by lomega under the trade name ZipDrive,® removable media drives using hard drive technology, or optical drives including CD ROM and DVD drives. It is expected that current technology for the attachment of peripherals will advance and the peripheral connection area 20 will be changes to provide different attachment methods to keep with the current technology.

A use of the peripheral connection area 20 for utilizing an external monitor 13 has been described above and it would be typical when using an external monitor 13 to also attach a conventional full sized keyboard (not shown).

FIG. 4 shows another embodiment of the wall mount computer 10 where the wall mount computer 10 has been specialized to include communications functions. This embodiment of the wall mount computer 10 integrates a telephone 22 and a printer 24 into the wall mount computer. The telephone 22 has a conventional handset and touch-tone dialing pad for use and is used as a conventional telephone accessing the user's usual telephone lines. The telephone 22, however, communicates through the communications cable 38 with the other telephones both within and without the structure.

The integrated printer 24 is a small printer to be used to print short notes, lists, or other limited quantities of data. The printer 24 can be a printer utilizing conventional technology, such as ink jet or thermal printing. It is preferred that the printer 24 utilizes rolls of paper so that a paper supply can be stored within the wall mount computer 10 and when actuated, the printer 24 can eject the printed paper through the paper slot 26 where the user may simply tear off the length of printed paper.

The integrated printer 24 can be designed for only limited quantities of printing as conventional general purpose printers will be attached to other wall mount computer 10 to provide for printing more voluminous printing tasks.

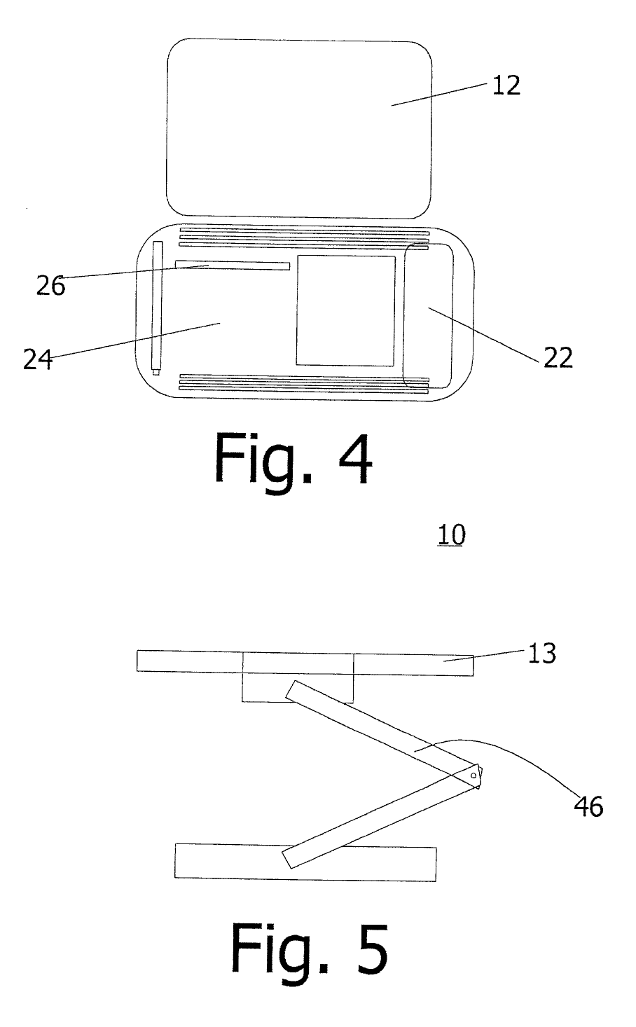

FIG. 5 shows a plan view of the preferred embodiment of a kitchen wall mounted computer 10. In this embodiment, the screen may be either a touch screen 12 or a conventional screen 13 and the screen is attached to the wall mount computer 10 using an articulated arm 46. The articulated arm 46 allows the user to move the screen 12 or 13 to a convenient location for viewing while working. This allows the user to place the screen 13 in a position for, for example, the side rather than straight on.

In a second preferred embodiment of the specialized kitchen wall mount computer 10 (not shown), is much as the wall mount computer shown in FIG. 4 with the screen 12 or 13 being pivotally attached to the wall mount computer 10. When constructed in this manner, the screen 13 may be pivoted to a storage location where the screen 13 is not visible.

In its use, the wall mount computers 10 must be first installed in a structure. The user will select the preferred locations for the wall mount computers 10 and have the wall mount computers 10 so installed. The installation will be much as described above and will vary dependant on whether the installation is in new construction or remodeling.

Once the locations for the wall mount computers 10 has been selected and the computers installed, the proper function modules 44 will be installed in the chassis and a selected screen 12 or 13 installed. Where appropriate, external keyboards, external monitors, printers, and the like will be installed and attached. The multiple wall mount computers 10 and the networking will be tested. When the wall mount computers 10 are working then the selected software may be installed.

The software installed on the wall mount computers 10 will depend on the intended use of the individual wall mount computer. Obviously, each wall mount computer will have a selected operating system installed and the selected software to allow communications among the wall mount computers 10. The wall mount computers that will be placed for use as a general use computer will have the typical software installed, such as, word processing, spread sheet, accounting, etc. A specialized wall mount computer such as a security system controller would have the software necessary to control the security system installed.

A kitchen wall mount computer 10 would have the kitchen software installed, such as the recipe programs and perhaps when technology allows, a bar coding system to maintain a kitchen inventory.

When installation is complete, the system of wall mount computers 10 assumes the converged control of many systems within the structure. The heating and cooling can be controlled using standard sensors interfaces to the software of the wall mount computer 10 system.

The communications with the outside world can be transmitted through the network of wall mount computers 10 so that a telephone can be simply plugged into a jack in one or more of the wall mount computers 10 for use.

Furthermore broadband communications, such as digital cable television signals, internet connectivity, and within the house intercommunications of like signals can be carried among the multiple wall mount computers 10. This would allow connection of a conventional television to one of the wall mount computers 10 and the input signal to the television may then be taken from either an external source such as a cable or from an internal source such as a remote DVD player or other sources attached to another wall mount computer. In this use, the system of wall mount computers 10 has become a media controller providing the ability to have a remote source of media, either audio or video.

The use of multiple wall mount computers 10 provides the for the convergence of all of the digital systems within a structure or home. The user thence has all of the appropriate resources available at his fingertips for easy and convenient use.

Although the present invention has been described with reference to preferred embodiments, workers skilled in the art will recognize changes may be made in form and detail without departing from the spirit and scope of the invention.

What is claimed:

1. A control system for a building, the building having walls and each of the walls containing a plurality of studs, the control system comprising:
a. at least one control and communications module attached to and affixed in a wall of the building, the control module comprising a chassis sized to fit between and attach to a pair of adjacent studs, the chassis further being adapted to accept at least one function module;
b. at least one means for providing input to the at least one function module;
c. at least one means for providing human sensible output from the at least one function module;
d. means for providing communications among the at least one control and communications modules.

2. The apparatus as described in claim 1 wherein the width of the chassis is sized to fit between two adjacent studs.

3. The apparatus as described in claim 2 wherein the width of the chassis is selected from the group consisting of the nominal widths of 14.5 inches and 22.5 inches.

4. The apparatus as described in claim 1 wherein the means for providing input is a keyboard.

5. The apparatus as described in claim 1 wherein the means for providing input further comprises a touch screen and a keyboard.

6. The apparatus as described in claim 1 wherein the means for providing input further comprises a microphone and a digitizer for accepting aural input and converting the aural input to commands for execution.

7. The control system as described in claim 1 wherein the means for providing communications among the at least one control and communications modules is adapted to carry digital data decodable to sound or pictures.

8. The control system as described in claim 1 wherein the means for providing input includes at least one sensor for measuring environmental parameters.

9. In a building, a modular system for controlling and communicating comprising:
a. at least one modular chassis adapted for fitment within a wall of the building, the module comprising
i.) a chassis adapted to fit within and attach to the wall;
ii.) at least on function module installable within the chassis;
iii.) means for providing user sensable input;
iv.) means for providing user sensable output;
b. means for communicating among the at least one modular chassis.

10. The apparatus as described in claim 9 wherein the means for providing input is a keyboard.

11. The apparatus as described in claim 9 wherein the means for providing input further comprises a touch screen and a keyboard.

12. A permanently wall mounted computer system integrated into the walls of a structure and having at least one computer, each computer comprising:
a. a chassis placed within and attached to the wall;
b. at least one function module removably attached to the chassis;
c. means for communicating among the at least one computer;
d. means for providing user input;
e. means for providing user sensible output.

13. The apparatus as described in claim 12 wherein the means for providing input is a keyboard.

14. The apparatus as described in claim 12 wherein the means for providing input further comprises a touch screen and a keyboard.
